(19) United States
(12) Patent Application Publication
(10) Pub. No.: US 2026/0067129 A1
(43) Pub. Date: Mar. 5, 2026

(54) IN-VEHICLE NETWORK SYSTEM AND CONTROL METHOD

(71) Applicant: DENSO CORPORATION, Kariya-city (JP)

(72) Inventors: Sho Matsumoto, Kariya-city (JP); Tomohisa Kishigami, Kariya-city (JP); Youichi Hayase, Kariya-city (JP)

(21) Appl. No.: 19/287,368

(22) Filed: Jul. 31, 2025

(30) Foreign Application Priority Data
Sep. 5, 2024 (JP) 2024-153410

(51) Int. Cl. H04L 12/40; B60R 16/023

(52) U.S. Cl. CPC H04L 12/40039; B60R 16/023; H04L 2012/40273

(57) ABSTRACT

An in-vehicle network system includes at least one upper control device and lower control devices. The upper control device is configured to turn on and off at least one relay circuit provided in a power supply line, and to receive a network management message, instruct to turn on the relay circuit provided in the power supply line of the lower control device, and supply power to the lower control device. The at least one relay circuit is connected to at least two of the lower control devices. The upper control device instructs to turn on the relay circuit to which the at least two of the lower control devices are connected.

### CROSS REFERENCE TO RELATED APPLICATION

This application is based on Japanese Patent Application No. 2024-153410 filed on Sep. 5, 2024, the disclosure of which is incorporated herein by reference.

### TECHNICAL FIELD

The present disclosure relates to an in-vehicle network system which includes a plurality of control devices connected to a communication bus and capable of mutual communication within a vehicle, and a control method for the in-vehicle network system.

### BACKGROUND

For example, a related art discloses an in-vehicle network system including an upper ECU, an intermediate ECU, and a lower ECU. In the in-vehicle network system, the intermediate ECU is supplied with power from a power source and supplies power from the power source to the lower ECU in response to a message received from the upper ECU. In other words, the intermediate ECU maintains the lower ECU in a power-off state until a message is received from the upper ECU. Upon receiving a message from the upper ECU at the intermediate ECU, the lower ECU is supplied with power from the power source. The lower ECU transitions from the power-off state to a standby state waiting for instructions due to the power supply.

### SUMMARY

According to an aspect of the present disclosure, an in-vehicle network system includes at least one upper control device and a plurality of lower control devices. The upper control device may include a power management unit configured to turn on and off at least one relay circuit provided in a power supply line of each of the plurality of the lower control devices, and a startup management unit configured to receive, on behalf of the plurality of the lower control devices, a network management message that is transmitted via the communication bus and selectively instructs a startup of the plurality of the lower control devices, instruct the power management unit to turn on the relay circuit provided in the power supply line of the lower control device for which startup is instructed by the network management message, and supply power to the lower control device for which the startup is instructed. The at least one relay circuit among a plurality of relay circuits may be connected to at least two of the lower control devices. The startup management unit may instruct the power management unit to turn on the relay circuit to which the at least two of the lower control devices are connected when startup of the at least one of the lower control devices among at least two of the lower control devices is instructed by the network management message.

### BRIEF DESCRIPTION OF DRAWINGS

Objects, features and advantages of the present disclosure will become more apparent from the following detailed description made with reference to the accompanying drawings. In the drawings:

FIG. 1 is a configuration diagram showing an example of the configuration of an in-vehicle network system according to the first embodiment;

FIG. 2 is an explanatory diagram for explaining an example of an NM message, PN request information, and PNC configuration information;

FIG. 3 is a diagram showing an example of a PNC configuration table stored in the storage unit of the power/startup management ECU;

FIG. 4 is a diagram showing an example of relay connection information stored in the storage unit of the power/startup management ECU;

FIG. 5 is an explanatory diagram for explaining an example of calculating common PNC configuration information based on the logical OR of the clusters of each PNC configuration information of lower ECUs;

FIG. 6 is a flowchart showing the process executed in the power/startup management ECU and the process executed in the lower ECU according to the first embodiment;

FIG. 7 is a flowchart showing the details of the PNC calculation process in the flowchart of FIG. 6;

FIG. 8 is a flowchart showing the details of the startup ECU identification process in the flowchart of FIG. 6; and

FIG. 9 is a configuration diagram showing an example of the configuration of an in-vehicle network system according to the second embodiment.

### DETAILED DESCRIPTION

In the in-vehicle network system described in a related art, the lower ECU remains in a power-off state until the intermediate ECU receives a message from the upper ECU. Therefore, compared to simply setting the lower ECU to a standby state, it is possible to reduce power consumption in the lower ECU.

In the in-vehicle network system described in the related art, the intermediate ECU is configured to supply power from the power source to all lower ECUs upon receiving a message from the upper ECU. In other words, the multiple lower ECUs connected to the intermediate ECU always receive power supply or cessation simultaneously. Consequently, it is difficult to finely manage the power supply and cessation to the lower ECUs in the in-vehicle network system described in the related art.

To enable fine management of power supply and cessation to the lower ECUs, it is conceivable to provide multiple relay circuits in each power supply line of the multiple lower ECUs, and configure the intermediate ECU to turn on the relay circuit for the lower ECU for which power supply is instructed by the message, and turn off the relay circuit for the lower ECU for which power supply is not instructed.

If multiple lower ECUs are connected to at least one of the relay circuits among the multiple relay circuits, and these multiple lower ECUs are not necessarily instructed to supply or cease power at the same timing by the message, a difficulty may arise regarding how to control the on/off state of the relay circuit.

The present disclosure provides an in-vehicle network system and a control method for an in-vehicle network system that can appropriately implement power supply to multiple lower control devices via one relay circuit, even when multiple lower control devices are connected to the one relay circuit and are not necessarily instructed to supply or cease power at the same timing.

According to an aspect of the present disclosure, an in-vehicle network system includes a plurality of control devices connected to a communication bus and capable of communicating with each other in a vehicle. The plurality of the control devices includes at least one upper control device and a plurality of lower control devices. The upper control device includes a power management unit configured to turn on and off at least one relay circuit provided in a power supply line of each of the plurality of the lower control devices, and a startup management unit configured to receive, on behalf of the plurality of the lower control devices, a network management message that is transmitted via the communication bus and selectively instructs a startup of a plurality of the lower control devices, instruct the power management unit to turn on the relay circuit provided in the power supply line of the lower control device for which startup is instructed by the network management message, and supply power to the lower control device for which the startup is instructed. At least one of the relay circuits among the plurality of the relay circuits is connected to at least two of the lower control devices. The startup management unit instructs the power management unit to turn on the relay circuit to which the at least two of the lower control devices are connected when startup of the at least one of the lower control devices among at least two of the lower control devices is instructed by the network management message.

According to an aspect of the present disclosure, a method for controlling an in-vehicle network system including a plurality of control devices connected to a communication bus and capable of communicating with each other in a vehicle is provided. The plurality of the control devices includes at least one upper control device and a plurality of lower control devices. The upper control device includes a power management unit configured to turn on and off at least one relay circuit provided in a power supply line of each of the plurality of the lower control devices. The method includes: receiving, on behalf of the plurality of the lower control devices, by the upper control device, a network management message that is transmitted via the communication bus and selectively instructs startup of the plurality of the lower control devices, and supplying power to the lower control device for which the startup is instructed by turning on the relay circuit provided in the power supply line of the lower control device for which the startup is instructed by the network management message. At least one of the relay circuits among the plurality of the relay circuits is connected to at least two of the lower control devices. Supplying power to the lower control devices includes turning on the relay circuit to which at least two of the lower control devices are connected when startup of at least one of the lower control devices among the at least two of the lower control devices is instructed by the network management message and supplying power to the at least two of the lower control devices.

According to the in-vehicle network system and the method for controlling the in-vehicle network system disclosed herein, the upper control device receives, on behalf of a plurality of lower control device, a network management message that is transmitted via a communication bus and selectively instructs startup of the plurality of the lower control devices. The upper control device turns on a relay circuit provided in the power supply line of the lower control device for which startup is instructed by the network management message, supplies power to the lower control device, and brings to a startup state. The upper control device turns on the relay circuit to which the at least two of the lower control devices are connected when startup of the at least one of the lower control devices among at least two of the lower control devices is instructed by the network management message.

Therefore, according to the in-vehicle network system and the control method for the in-vehicle network system of the present disclosure, it is possible to appropriately implement power supply to multiple lower control devices via one relay circuit, even when multiple lower control devices are connected to the one relay circuit and are not necessarily instructed to supply or cease power at the same timing.

Embodiments of the in-vehicle network system and a control method for the in-vehicle network system according to the present disclosure will be described with reference to the drawings. However, the present disclosure is not limited to the following embodiments, and various modifications described later are also included within the technical scope of the present disclosure. Furthermore, various changes can be made without departing from the spirit of the present disclosure. Embodiments and various modifications can be appropriately combined as long as no technical contradictions arise. In the following description, identical or similar configurations may be assigned the same reference numbers across multiple drawings, and explanations may be omitted. Additionally, when referring to only part of a configuration, explanations provided elsewhere may be applied to other parts.

### First Embodiment

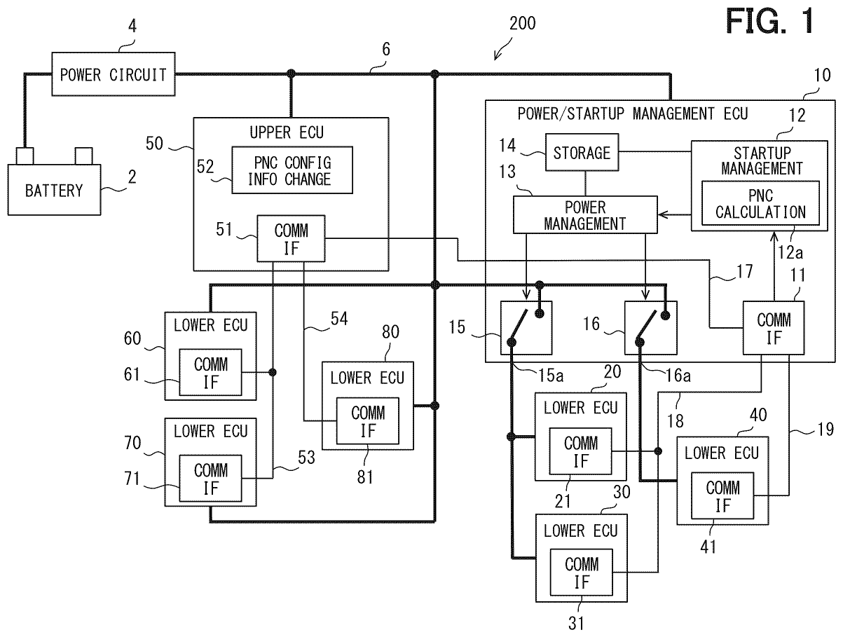

FIG. 1 is a configuration diagram showing an example of the configuration of the in-vehicle network system 200 according to this embodiment. As shown in FIG. 1, the in-vehicle network system 200 includes a power/startup management ECU 10 and an upper ECU 50 as upper control devices, as well as first to sixth lower ECUs 20, 30, 40, 60, 70, 80 as lower control devices. ECU stands for Electronic Control Unit. A power supply line 6 of the first to third lower ECUs 20, 30, 40 is equipped with first and second relay circuits 15, 16, which are switched on and off by the power/startup management ECU 10. On the other hand, the fourth to sixth lower ECUs 60, 70, 80 are directly supplied with power from the power circuit 4 without passing through relay circuits like the first and second relay circuits 15, 16.

The power/startup management ECU 10, the upper ECU 50, and the first to sixth lower ECUs 20, 30, 40, 60, 70, 80 can each be configured by computers equipped with processors, memory, and storage. They also include communication interfaces (referred to as a communication IFs) 11, 21, 31, 41, 51, 61, 71, 81 for communicating with other ECUs via communication buses 17, 18, 19, 53, 54.

More specifically, the communication IF 11 of the power/startup management ECU 10 is connected to the communication IF 51 of the upper ECU 50 via the communication bus 17. Additionally, the communication IF 11 of the power/startup management ECU 10 is connected to the communication IFs 21, 31 of the first and second lower ECUs 20, 30 via the communication bus 18. Furthermore, the communication IF 11 of the power/startup management ECU 10 is connected to the communication IF 41 of the third lower ECU 40 via the communication bus 19. The communication IF 51 of the upper ECU 50 is connected to the communication IFs 61, 71 of the fourth and fifth lower ECUs 60, 70 via the communication bus 53. Additionally, the communication IF 51 of the upper ECU 50 is connected to the communication IF 81 of the sixth lower ECU 80 via the communication bus 54. The communication IFs 11 and 51 of the power/startup management ECU 10 and upper ECU 50 are configured to function as gateways when the first to sixth lower ECUs 20, 30, 40, 60, 70, 80 connected to different communication buses 18, 19, 53, 54 communicate with each other.

The processor may be a CPU (Central Processing Unit), MPU (Micro Processing Unit), GPU (Graphics Processing Unit), DFP (Data Flow Processor), or other devices that execute predetermined processing according to a program. The memory is a volatile storage medium, such as RAM (Random Access Memory), that temporarily stores calculation results from the processor. The storage is a non-volatile storage medium, such as flash memory or ROM (Read Only Memory). Various programs and data executed by the processor are stored in the storage. Some or all of the functions provided by the power/startup management ECU 10, upper ECU 50, and first to sixth lower ECUs 20, 30, 40, 60, 70, 80 may be implemented in hardware using, for example, ASIC (Application Specific Integrated Circuit) or FPGA (Field-Programmable Gate Array) instead of software.

The in-vehicle network system 200 can use CAN (Controller Area Network) as the communication protocol for mutual communication between the power/startup management ECU 10, the upper ECU 50, and first to sixth lower ECUs 20, 30, 40, 60, 70, 80. CAN is a registered trademark. The communication protocol is not limited to CAN. The in-vehicle network system 200 may adopt another communication protocol, such as CAN-FD (CAN with Flexible Data Rate). In this embodiment, the first to sixth lower ECUs 20, 30, 40, 60, 70, 80 are divided into multiple groups (referred to as clusters) for each ECU that needs to be started simultaneously to realize at least one desired function. Using the network management (NM) message described later, the normal operation mode (also referred to as a startup state) and power-saving mode (e.g., a sleep state) are switched for each cluster. The power-saving mode includes the power-off state of the first to third lower ECUs 20, 30, 40. Therefore, the communication protocol adopted by the in-vehicle network system 200 must support the transmission and reception of NM messages.

The power/startup management ECU 10 and the upper ECU 50 can each function as domain controllers overseeing the control of the first to third lower ECUs 20, 30, 40, and the fourth to sixth lower ECUs 60, 70, 80, respectively. A domain refers to a unit of function when broadly dividing the vehicle's functions, such as the powertrain domain, chassis domain, advanced driver assistance domain, body domain, cockpit domain, etc. The above is an example of domain division. The domain division may differ from the examples mentioned. Additionally, the power/startup management ECU 10 and the upper ECU 50 may each function as area controllers overseeing the control of the first to third lower ECUs 20, 30, 40, and the fourth to sixth lower ECUs 60, 70, 80 arranged in each area of the vehicle.

The first to third lower ECUs 20, 30, 40, and the fourth to sixth lower ECUs 60, 70, 80 may be control ECUs for controlling predetermined control targets in the vehicle or sensor ECUs for calculating predetermined physical quantities based on detection signals detected by sensors. When it is necessary to control the control target or calculate predetermined physical quantities based on sensor detection signals, the first to third lower ECUs 20, 30, 40, and the fourth to sixth lower ECUs 60, 70, 80 transition to the startup state in the normal operation mode and execute normal operations. Conversely, when it is not necessary to control the control target or calculate predetermined physical quantities, the first to third lower ECUs 20, 30, 40, and the fourth to sixth lower ECUs 60, 70, 80 enter the power-saving mode, transitioning to the power-off state or sleep state.

To switch between the startup state and the power-off state or sleep state, the first to third lower ECUs 20, 30, 40, and the fourth to sixth lower ECUs 60, 70, 80 are each assigned to a cluster within the multiple divided clusters to which they belong. The assigned cluster is held by each ECU as cluster configuration information (also referred to as PNC configuration information). PNC stands for Partial Networking Clustering. However, the PNC configuration information of the first to third lower ECUs 20, 30, 40 is stored in a storage unit 14 of the power/startup management ECU 10 as described later. Then, in response to the startup cluster information (also referred to as PN request information) included in the NM message, the first to third lower ECUs 20, 30, 40, and the fourth to sixth lower ECUs 60, 70, 80 are configured to switch from the power-off state or sleep state to the startup state.

When the first to third lower ECUs 20, 30, 40, and the fourth to sixth lower ECUs 60, 70, 80 transition to the startup state and normal operation mode, they periodically transmit NM messages to other ECUs while performing normal operations. After performing the necessary processing, when the first to third lower ECUs 20, 30, 40, and the fourth to sixth lower ECUs 60, 70, 80 no longer need to execute normal operations, they stop the periodic transmission of NM messages. The fourth to sixth lower ECUs 60, 70, 80 transition from the normal operation mode to the power-saving mode, switching from the startup state to the sleep state when the time without receiving NM messages from other ECUs belonging to the same cluster reaches a predetermined standby time. Regarding the first to third lower ECUs 20, 30, 40, the NM messages directed to them are monitored by the power/startup management ECU 10. When the time without receiving NM messages directed to the first to third lower ECUs 20, 30, 40 reaches a predetermined standby time, the power/startup management ECU 10 turns off the first and second relay circuits 15, 16, stopping the power supply to the first to third lower ECUs 20, 30, 40.

The fourth to sixth lower ECUs 60, 70, 80 have communication IFs 61, 71, 81 capable of receiving NM messages in the sleep state and switching from the sleep state to the startup state in response to receiving NM messages. When switched to the startup state by the communication IFs 61, 71, 81, the fourth to sixth lower ECUs 60, 70, 80 each determine whether their startup is requested based on the PN request information and PNC configuration information. If it is determined that their startup is requested, the fourth to sixth lower ECUs 60, 70, 80 continue in the startup state. Conversely, if it is determined that their startup is not requested, the fourth to sixth lower ECUs 60, 70, 80 return to the sleep state. The communication IFs 61, 71, 81 may execute the determination based on the PN request information and PNC configuration information. In this case, when the communication IFs 61, 71, 81 determine that startup is requested based on the PN request information and PNC configuration information, they transition the corresponding ECU from the sleep state to the startup state. An example of NM messages, PN request information, and PNC configuration information will be described in detail.

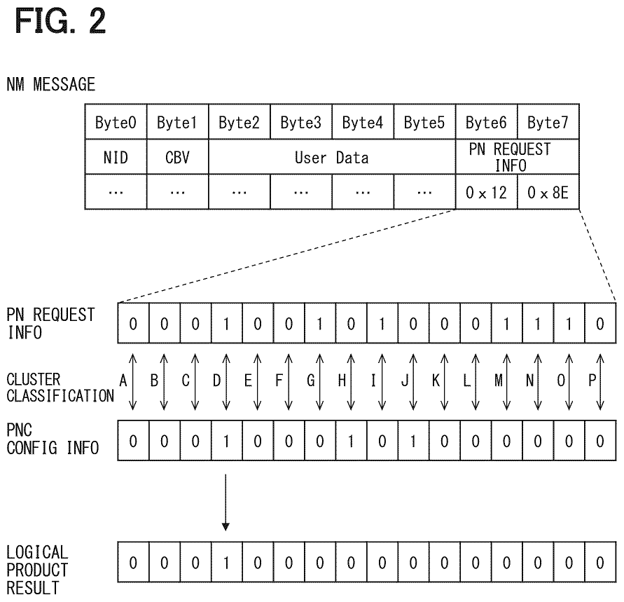

The NM message includes data from byte 0 to byte 7, as shown in FIG. 2. Byte 0 contains the Node ID (NID). The Node ID is a unique identifier for each of the power/startup management ECU 10, upper ECU 50, and first to sixth lower ECUs 20, 30, 40, 60, 70, 80. The Node ID allows identification of the sender of the NM message. Byte 1 contains the Control Bit Vector (CBV). The Control Bit Vector indicates whether partial networking is used. When the Control Bit Vector indicates the use of partial networking, the user data area from byte 2 to byte 7 includes PN request information, which is startup cluster information indicating the cluster to be started. Partial networking means setting only the ECUs belonging to some clusters to the startup state while setting the ECUs belonging to the remaining clusters to the power-off state or sleep state. By setting only the ECUs that need to operate to the startup state, power consumption by each ECU installed in the vehicle can be reduced.

In the example shown in FIG. 2, the Control Bit Vector indicates the use of partial networking, and PN request information is stored in bytes 6 and 7 of the user data area. The user data area from byte 2 to byte 5 can be used to transmit any information, such as ECU startup factors or information related to normal or abnormal conditions. FIG. 2 merely shows an example of the format of the NM message, and the NM message may have other formats as long as it includes the presence or absence of partial networking and PN request information. For example, the positions of NID and CBV may be reversed.

The PN request information indicates the startup cluster to be started and the cluster that does not need to be started for each of the multiple divided clusters. More specifically, in the example shown in FIG. 2, the clusters are pre-divided into 16. The PN request information includes 16-bit data corresponding to the 16 divided clusters. That is, the 16-bit data of the PN request information is pre-associated with the 16 divided clusters. When each 16-bit data of the PN request information is “0,” it indicates that the startup of the associated cluster is unnecessary. Conversely, when each 16-bit data of the PN request information is “1,” it indicates that the startup of the associated cluster is necessary.

The first to sixth lower ECUs 20, 30, 40, 60, 70, 80 have the PNC configuration information indicating the cluster to which they belong within the multiple divided clusters, as described above. An example of the PNC configuration information is shown in FIG. 2. More specifically, FIG. 2 shows an example of the PNC configuration information held by any one of the first to sixth lower ECUs 20, 30, 40, 60, 70, 80. In the PNC configuration information shown in FIG. 2, when classified from left to right in the figure as clusters A to P, the PNC configuration information indicates that the ECU holding the PNC configuration information belongs to clusters D, H, J. The first to sixth lower ECUs 20, 30, 40, 60, 70, 80 can belong to one or more clusters because they can exhibit various functions through program execution.

When the fourth to sixth lower ECUs 60, 70, 80 receive NM messages containing PN request information via their communication IFs 61, 71, 81, as shown in FIG. 2, they compare the PN request information and the PNC configuration information bit by bit, for example, calculating the logical AND. That is, when NM messages are received at their communication IFs 61, 71, 81, the fourth to sixth lower ECUs 60, 70, 80 temporarily enter the startup state. Then, the fourth to sixth lower ECUs 60, 70, 80 determine whether the cluster requested to be started by the PN request information included in the NM message matches the cluster of the PNC configuration information assigned to each of the fourth to sixth lower ECUs 60, 70, 80. For example, in the example shown in FIG. 2, the clusters requested to be started by the PN request information are clusters D, G, I, M, N, O. The clusters indicated by the PNC configuration information to which the ECU belongs are clusters D, H, J. In this case, the cluster requested to be started by the PN request information included in the NM message matches the cluster of the PNC configuration information in cluster D. Therefore, as shown in FIG. 2, the result of the logical AND is “1” in cluster D.

If any bit of the logical AND result is “1,” the ECU with the PNC configuration information shown in FIG. 2 determines that its startup is requested. Based on the determination result, the ECU with the PNC configuration information shown in FIG. 2 remains transitioned from the sleep state to the startup state and maintains the startup state if it is already in the startup state. Conversely, if none of the bits of the logical AND result is “1” and all are “0,” the ECU with the PNC configuration information shown in FIG. 2 determines that its startup is not requested. In this case, the ECU with the PNC configuration information shown in FIG. 2 discards the received NM message and returns to the sleep state.

Thus, the fourth to sixth lower ECUs 60, 70, 80 have the function to identify whether the NM message requests their startup based on the PNC configuration information. With this function to identify the NM message, only the fourth to sixth lower ECUs 60, 70, 80 having PNC configuration information that includes the cluster requested to be started by the PN request information enter the startup state due to the NM message. An ECU equipped with the function to receive a NM message in the sleep state and switch from the sleep state to the startup state is referred to as a NM compatible ECU.

In the in-vehicle network system 200 according to this embodiment, the first to third lower ECUs 20, 30, 40 are not NM compatible ECUs. In other words, the first to third lower ECUs 20, 30, 40 are all NM non-compatible ECUs. NM compatible ECUs, as described above, have communication IFs that receive NM messages in the sleep state and switch from the sleep state to the startup state. Therefore, NM compatible ECUs are more expensive compared to NM non-compatible ECUs. The first to third lower ECUs 20, 30, 40, as described above, are NM non-compatible ECUs. Therefore, using the first to third lower ECUs 20, 30, 40, which are NM non-compatible ECUs, as lower control devices can reduce the overall cost of the in-vehicle network system 200.

The in-vehicle network system 200 according to this embodiment is configured such that the power/startup management ECU 10 enables the first to third lower ECUs 20, 30, 40, which are all NM non-compatible ECUs, to be subject to partial networking in response to NM messages. The power/startup management ECU 10 according to this embodiment will be described in detail.

As shown in FIG. 1, the power/startup management ECU 10 includes the communication IF 11, a startup management unit 12, a power management unit 13, the storage unit 14, and first and second relay circuits 15, 16. The startup management unit 12 and the power management unit 13 are functional units constructed within the power/startup management ECU 10 through software and/or hardware. The storage unit 14 can be configured by the storage of the power/startup management ECU 10.

The first relay circuit 15 is provided in the power supply line 6 to supply power to the first and second lower ECUs 20, 30. In other words, the power lines of the first and second lower ECUs 20, 30 are connected to a first power port 15a connected to the first relay circuit 15. The second relay circuit 16 is provided in the power supply line 6 to supply power to the third lower ECU 40. In other words, the power line of the third lower ECU 40 is connected to the second power port 16a connected to the second relay circuit 16.

The number of relay circuits provided in the power/startup management ECU 10 is not limited to two, and there may be three or more. Additionally, in the in-vehicle network system 200, there may be multiple sets of combinations of upper ECUs capable of turning the power supply to lower ECUs on and off, rather than just one set.

The power circuit 4 can convert the power voltage of the battery 2 installed in the vehicle to the operating voltage of the power/startup management ECU 10, the upper ECU 50, and first to sixth lower ECUs 20, 30, 40, 60, 70, 80 as needed. The power supply line 6 to the power/startup management ECU 10, the upper ECU 50, and first to sixth lower ECUs 20, 30, 40, 60, 70, 80 is supplied with voltage from the power circuit 4.

The first and second relay circuits 15, 16 can be configured using semiconductor switches such as MOSFETs or IGBTs. However, the first and second relay circuits 15, 16 may also be configured using conventional mechanical relays instead of semiconductor switches. Furthermore, as shown in FIG. 1, the first and second relay circuits 15, 16 may be provided inside or outside the power/startup management ECU 10.

The power/startup management ECU 10 is an NM compatible ECU capable of receiving NM messages. As described above, the first to third lower ECUs 20, 30, 40 are NM non-compatible ECUs. In this embodiment, the first to third lower ECUs 20, 30, 40 enter a power-off state in the power-saving mode when operation is unnecessary. Therefore, the first to third lower ECUs 20, 30, 40 cannot receive NM messages when in the power-saving mode. As a result, the communication IF 11 of the power/startup management ECU 10 receives NM messages that selectively instruct the startup of the first to third lower ECUs 20, 30, 40 on their behalf. The NM messages received by the communication IF 11 are provided to the startup management unit 12.

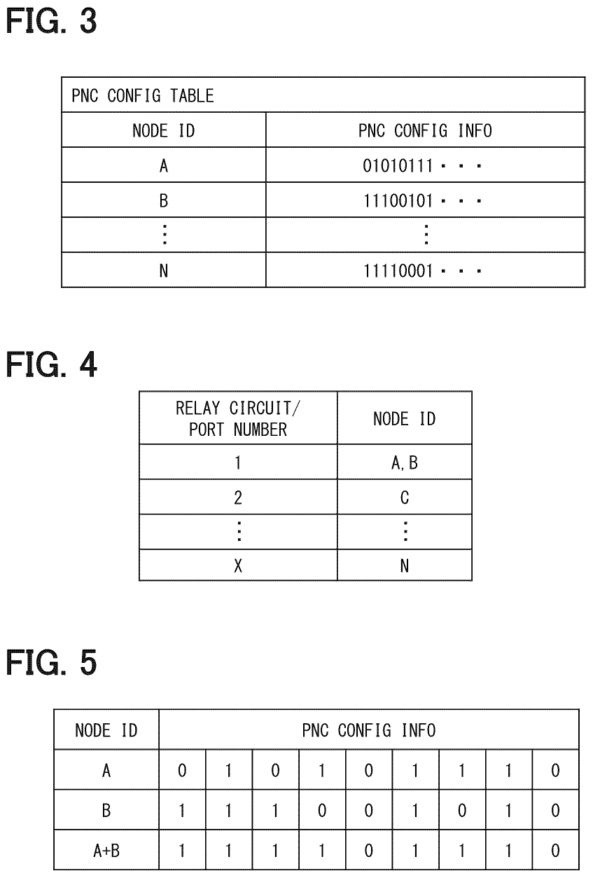

Here, the storage unit 14 of the power/startup management ECU 10 stores, in addition to programs executed by the processor of the power/startup management ECU 10, the PNC configuration information indicating the clusters to which each of the first to third lower ECUs 20, 30, 40 belongs. Furthermore, the storage unit 14 stores relay connection information indicating the correspondence between the first and second relay circuits 15, 16 and the first to third lower ECUs 20, 30, 40. For example, the storage unit 14 stores PNC configuration information, which indicates the clusters assigned to each of the first to third lower ECUs 20, 30, 40 using a PNC configuration table as illustrated in FIG. 3. The PNC configuration table exemplified in FIG. 3 shows the correspondence between the Node IDs, which are unique identifiers of multiple lower ECUs including the first to third lower ECUs 20, 30, 40, and the PNC configuration information assigned to multiple lower ECUs including the first to third lower ECUs 20, 30, 40. Additionally, the storage unit 14 stores the correspondence between the numbers or power port numbers of multiple relay circuits, including the first and second relay circuits 15, 16, and the Node IDs, which are unique identifiers of multiple lower ECUs including the first to third lower ECUs 20, 30, 40, as relay connection information, as exemplified in FIG. 4.

The startup management unit 12 of the power/startup management ECU 10 can acquire the PNC configuration information of each of the first to third lower ECUs 20, 30, 40 by referring to the PNC configuration table exemplified in FIG. 3. The startup management unit 12 then determines, based on the acquired PNC configuration information of the first to third lower ECUs 20, 30, 40 and the PN request information of the NM message, which lower ECU 20, 30, 40 has been instructed to start by the NM message. Specifically, the startup management unit 12 compares the PN request information of the NM message with the PNC configuration information of each of the lower ECUs 20, 30, 40 bit by bit. Based on the comparison result, if the startup management unit 12 determines that there is PNC configuration information containing a cluster requested to be started by the PN request information, it concludes that the startup of the lower ECUs 20, 30, 40 corresponding to that PNC configuration information has been instructed. In this case, the startup management unit 12 provides the node ID indicating the lower ECUs 20, 30, 40 instructed to start by the NM message to the power management unit 13. Conversely, if the startup management unit 12 determines that there is no PNC configuration information containing a cluster requested to be started by the PN request information, the received NM message does not instruct the startup of any lower ECU 20, 30, 40, and thus the NM message is discarded.

Upon receiving the node ID of the lower ECUs 20, 30, 40 instructed to start from the startup management unit 12, the power management unit 13 of the power/startup management ECU 10 refers to the relay connection information stored in the storage unit 14, which indicates the correspondence between each relay circuit 15, 16 and each lower ECU 20, 30, 40. The power management unit 13 then identifies the relay circuits 15, 16 corresponding to the node ID of the lower ECUs 20, 30, 40 instructed to start and outputs a drive signal to turn on the identified relay circuits 15, 16. Consequently, power is supplied through the relay circuits 15, 16 corresponding to the lower ECUs 20, 30, 40 instructed to start, and the corresponding lower ECUs 20, 30, 40 enter the startup state.

The first to third lower ECUs 20, 30, 40 control control target devices among various control target devices installed in the vehicle when specific conditions are met or only under specific environments (e.g., door lock mechanisms, power window drive motors, headlight light sources, wiper motors, AV equipment, etc.) or calculate predetermined physical quantities necessary for control based on detection signals from sensors. For example, the door lock mechanism is controlled by the door lock control ECU when the vehicle user attempts to enter or exit the vehicle. The power window drive motor is controlled by the power window control ECU when the window lift switch is operated by the user.

Thus, the first to third lower ECUs 20, 30, 40 control control target devices that operate only when specific conditions are met or under specific environments and calculate predetermined physical quantities necessary for control. Therefore, when the startup of the first to third lower ECUs 20, 30, 40 is instructed by the NM message, the power/startup management ECU 10 turns on the first and second relay circuits 15, 16 corresponding to the first to third lower ECUs 20, 30, 40 to supply power to them. Conversely, if the startup of the first to third lower ECUs 20, 30, 40 is not instructed by the NM message, the power/startup management ECU 10 turns off the first and second relay circuits 15, 16 to stop the power supply to the first to third lower ECUs 20, 30, 40. This allows the reduction of dark current when the operation of each lower ECU 20, 30, 40 is unnecessary, enabling further power savings for the entire in-vehicle system.

The NM message can be generated by the power/startup management ECU 10 and/or the upper ECU 50 as a function of a domain controller or area controller. In this case, the power/startup management ECU 10 and/or the upper ECU 50 determine the functions to be executed in the vehicle and, when the execution of a desired function is necessary, identify the cluster to which the ECUs that need to be simultaneously in the startup state to execute the relevant function belong, and generate an NM message containing PN request information specifying the startup cluster. The generated NM message is transmitted to the first to sixth lower ECUs 20, 30, 40, 60, 70, 80, etc., via communication buses 17, 18, 19, 53, 54. Furthermore, if the NM message is generated by the power/startup management ECU 10, for example, it is also used to determine whether the power/startup management ECU 10 itself should switch its lower ECUs 20, 30, 40 to the startup state. However, the function of determining the functions to be executed in the vehicle and transmitting the NM message containing PN request information may be possessed by other ECUs, such as the first to sixth lower ECUs 20, 30, 40, 60, 70, 80, instead of the power/startup management ECU 10 or the upper ECU 50.

Additionally, the power/startup management ECU 10 and/or the upper ECU 50 may enter the sleep state when all ECUs belonging to the in-vehicle network system 200 are in the sleep state or power-off state, and the time without receiving NM messages reaches a predetermined duration.

Furthermore, any ECU belonging to the in-vehicle network system 200, such as the power/startup management ECU 10 or the upper ECU 50, may be equipped with a PNC configuration information modification unit 52 that changes the PNC configuration information assigned to each lower ECU 20, 30, 40, 60, 70, 80. FIG. 1 shows an example where the PNC configuration information modification unit 52 is implemented in the upper ECU 50.

The upper ECU 50, equipped with the PNC configuration information modification unit 52, has an external communication device capable of wireless communication with external servers such as data centers. The upper ECU is configured to download application programs for realizing new functions in the vehicle or update programs for upgrading the programs already implemented in any ECU 10, 20, 30, 40, 50, 60, 70, 80 via the external communication device. The downloaded programs are provided to the relevant ECUs 10, 20, 30, 40, 50, 60, 70, 80 via communication buses 17, 18, 19, 53, 54, and the installation of new application programs or rewriting to update programs is executed. Note that the ECU communicating with the data center via the external communication device and the ECU where the PNC configuration information modification unit 52 is implemented may be separate ECUs.

Regarding the ECUs 10, 20, 30, 40, 50, 60, 70, 80 where new application programs or update programs are implemented, it may be necessary to add or change the startup conditions of the relevant ECUs depending on the functions of the application programs or update programs. Therefore, when it is necessary to add or change the startup conditions of the ECU where the application program or update program is implemented, the data center downloads new PNC configuration information corresponding to the addition or change of startup conditions to the upper ECU 50 along with the application program or update program.

When the PNC configuration information modification unit 52 acquires new PNC configuration information from the data center, the PNC configuration information modification unit 52 changes (rewrites) the PNC configuration information held by the ECUs 10, 20, 30, 40, 50, 60, 70, 80 where the application program or update program is implemented to the new PNC configuration information. As a result, the ECUs 10, 20, 30, 40, 50, 60, 70, 80 where the application program or update program is implemented are switched from the sleep state to the startup state according to the cluster indicated by the changed PNC configuration information. The rewriting of PNC configuration information may be executed by the relevant ECU upon receiving a rewrite instruction along with the new PNC configuration information from the PNC configuration information modification unit 52. Alternatively, the rewriting of PNC configuration information may be executed by the PNC configuration information modification unit 52 accessing the memory of the relevant ECU.

The PNC configuration information modification unit 52 can be provided outside the in-vehicle network system 200, such as in a data center, rather than in an ECU belonging to the in-vehicle network system 200. However, if the PNC configuration information modification unit 52 is implemented in an ECU belonging to the in-vehicle network system 200, communication with the outside can be terminated once the data for changing the ECU's PNC configuration information is acquired from the outside. On the other hand, if the PNC configuration information modification unit 52 is provided in an external server outside the in-vehicle network system 200, the ECU requiring a change in PNC configuration information must individually communicate with the external server via an ECU equipped with an external communication device. This may lead to increase of communication volume with the external server.

As shown in FIG. 1, when multiple first and second lower ECUs 20, 30 are connected to at least one first relay circuit 15 among the multiple first and second relay circuits 15, 16, and the PNC configuration information of these multiple first and second lower ECUs 20, 30 differs, and the power supply to, or cessation of power for, the multiple first and second lower ECUs 20, 30 does not necessarily occur simultaneously, a difficulty may arise regarding how to control the on/off state of the first relay circuit 15.

Therefore, in the in-vehicle network system 200 according to this embodiment, a PNC calculation unit 12a is provided in the startup management unit 12 as the common cluster configuration information calculation unit of the present disclosure. The PNC calculation unit 12a reads the PNC configuration information of each of the multiple first and second lower ECUs 20, 30 connected to the first relay circuit 15 from the storage unit 14. The PNC calculation unit 12a calculates the logical OR of the clusters of the PNC configuration information of each of the first and second lower ECUs 20, 30 that were read. The PNC calculation unit 12a then stores the calculated logical OR as common PNC configuration information shared by the first and second lower ECUs 20, 30, linked to the first relay circuit 15 in the storage unit 14. The PNC calculation unit 12a may be provided separately from the startup management unit 12.

For example, in the example shown in FIG. 5, the node ID of the first lower ECU 20 connected to the first relay circuit 15 is “A,” and its PNC configuration information is “010101110.” Similarly, the node ID of the second lower ECU 30 connected to the first relay circuit 15 is “B,” and its PNC configuration information is “111001010.” In this case, the PNC calculation unit 12a calculates the logical OR of the clusters of the PNC configuration information of the first and second lower ECUs 20, 30 as “111101110.” The PNC calculation unit 12a then stores the calculated logical OR as common PNC configuration information corresponding to node IDs “A, B” in the storage unit 14. By being stored as common PNC configuration information corresponding to node IDs “A, B,” the stored common PNC configuration information is linked to the first relay circuit 15.

When an NM message is received, the startup management unit 12 reads the common PNC configuration information from the storage unit 14 as the PNC configuration information for the first and second lower ECUs 20, 30. The startup management unit 12 then compares the PN request information of the NM message with the common PNC configuration information bit by bit. Based on the comparison result, if the startup management unit 12 determines that the common PNC configuration information includes a cluster requested to be started by the PN request information, it concludes that the startup of the first lower ECU 20 and/or the second lower ECU 30 has been instructed. In this case, the startup management unit 12 provides the node ID indicating the first lower ECU 20 and/or the second lower ECU 30 to the power management unit 13. Upon receiving the node ID indicating the first lower ECU 20 and/or the second lower ECU 30, the power management unit 13 turns on the first relay circuit 15 to which the first and second lower ECUs 20, 30 are connected.

Thus, in the in-vehicle network system 200 according to this embodiment, the power/startup management ECU 10 turns on the first relay circuit 15 to which the first and second lower ECUs 20, 30 are connected when the NM message instructs the startup of at least one of the first and second lower ECUs 20, 30 connected to the first relay circuit 15.

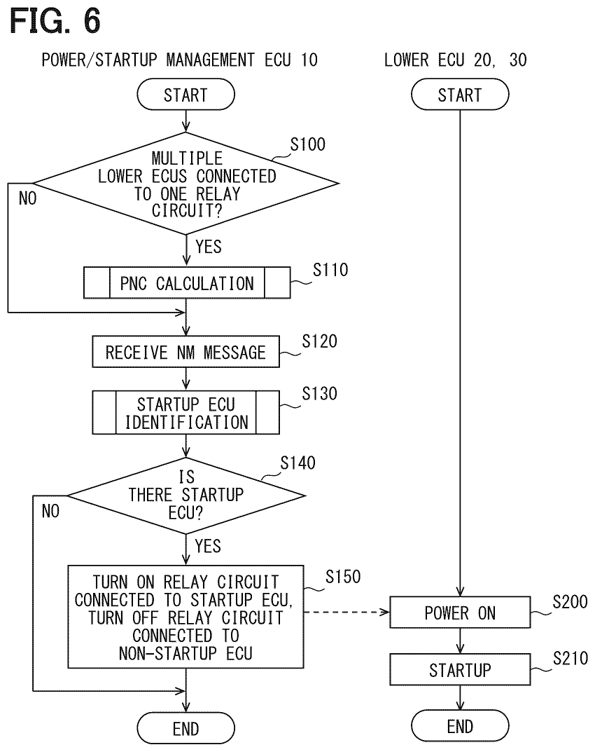

Next, an example of the process executed in the power/startup management ECU 10 will be described with reference to the flowcharts in FIG. 6 to FIG. 8.

In step S100, the power/startup management ECU 10 determines whether multiple lower ECUs are connected to at least one relay circuit by referring to the relay connection information. If it is determined that multiple lower ECUs are connected to at least one relay circuit, the power/startup management ECU 10 proceeds to step S110. Conversely, if it is determined that multiple lower ECUs are not connected to at least one relay circuit, the power/startup management ECU 10 proceeds to step S120.

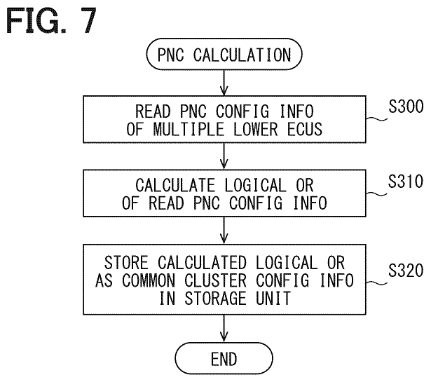

In step S110, the power/startup management ECU 10 executes the PNC calculation process. The PNC calculation process is executed for each relay circuit to which multiple lower ECUs are connected if there are multiple such relay circuits. The details of the PNC calculation process are shown in the flowchart of FIG. 7. The PNC calculation process will be described with reference to the flowchart in FIG. 7.

In step S300, the power/startup management ECU 10 reads the PNC configuration information of each of the multiple lower ECUs connected to one relay circuit from the storage unit 14. In step S310, the power/startup management ECU 10 calculates the logical OR of the clusters of the PNC configuration information of each of the multiple lower ECUs that were read. Then, in step S320, the power/startup management ECU 10 stores the calculated logical OR as common PNC configuration information shared by the multiple lower ECUs, linking it to one relay circuit in the storage unit 14.

If the common PNC configuration information has been calculated and stored in the storage unit 14, the process may proceed to step S120 without executing the PNC calculation process in step S110. In this case, it may be preferable for the power/startup management ECU 10 to delete the stored common PNC configuration information from the storage unit 14 in response to the PNC configuration information modification unit 52 changing the PNC configuration information of the first lower ECU 20 and/or the second lower ECU 30. This allows the PNC calculation process to calculate new common PNC configuration information based on the changed PNC configuration information.

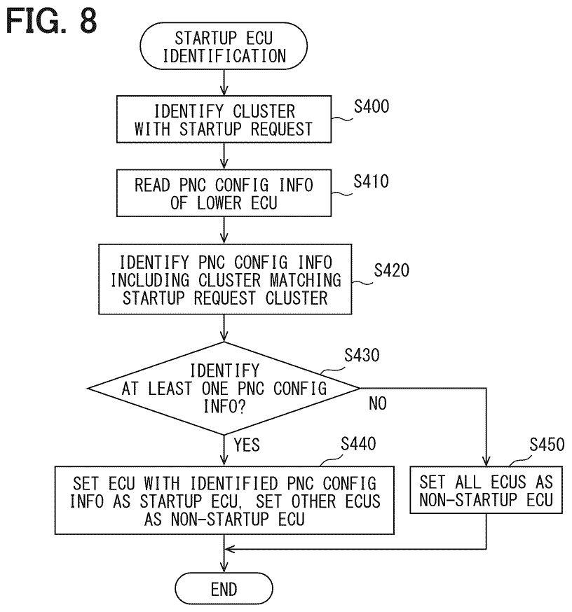

In step S120, the power/startup management ECU 10 receives or generates an NM message. In step S130, the power/startup management ECU 10 executes the startup ECU identification process to identify the lower ECUs 20, 30, 40 instructed to start by the NM message. The details of the startup ECU identification process are shown in the flowchart of FIG. 8. The startup ECU identification process will be described with reference to the flowchart in FIG. 8.

In step S400, the power/startup management ECU 10 identifies the clusters requested to be started based on the PN request information of the NM message. In step S410, the power/startup management ECU 10 reads the PNC configuration information of the multiple lower ECUs 20, 30, 40 from the storage unit 14. At this time, for the first and second lower ECUs 20, 30, the power/startup management ECU 10 reads the common PNC configuration information as the PNC configuration information. Then, in step S420, the power/startup management ECU 10 identifies the PNC configuration information that include clusters matching the clusters requested to be started (startup request clusters) by the PN request information and common PNC configuration information.

In step S430, the power/startup management ECU 10 determines whether at least one PNC configuration information among the PNC configuration information of the multiple lower ECUs 20, 30, 40 and common PNC configuration information has been identified as including a cluster matching the startup request cluster. If at least one PNC configuration information has been identified, the power/startup management ECU 10 proceeds to step S440. Conversely, if no PNC configuration information has been identified, the power/startup management ECU 10 proceeds to step S450.

In step S440, the power/startup management ECU 10 sets the lower ECUs 20, 30, 40 corresponding to the identified PNC configuration information as startup ECUs, and sets the other lower ECUs 20, 30, 40 as non-startup ECUs. If the common PNC configuration information has been identified as PNC configuration information including a cluster matching the startup request cluster of the PN request information, the power/startup management ECU 10 sets multiple lower ECUs 20, 30 connected to one relay circuit 15 as startup ECUs. In step S450, the power/startup management ECU 10 sets all lower ECUs 20, 30, 40 as non-startup ECUs. Afterward, the power/startup management ECU 10 returns to the process shown in the flowchart of FIG. 6.

In step S140 of the flowchart in FIG. 6, the power/startup management ECU 10 determines whether there are any lower ECUs 20, 30, 40 set as startup ECUs. If there are lower ECUs 20, 30, 40 set as startup ECUs, the power/startup management ECU 10 proceeds to step S150. Conversely, if there are no lower ECUs 20, 30, 40 set as startup ECUs, the power/startup management ECU 10 terminates the process shown in the flowchart of FIG. 6. In this case, the NM message is discarded.

In step S150, the power/startup management ECU 10 turns on the relay circuits 15, 16 connected to the lower ECUs 20, 30, 40 set as startup ECUs based on the relay connection information stored in the storage unit 14, which indicates the correspondence between each relay circuit 15, 16 and each lower ECU 20, 30, 40. The relay connection information includes the linkage between the common PNC configuration information and the relay circuits. Additionally, the power/startup management ECU 10 turns off the relay circuits 15, 16 connected to the lower ECUs 20, 30, 40 set as non-startup ECUs.

As shown in step S200 of the flowchart in FIG. 6, the lower ECUs 20, 30, 40 for which the relay circuits 15, 16 have been turned on begin receiving power. As a result, the lower ECUs 20, 30, 40 for which the relay circuits 15, 16 have been turned on undergo predetermined processing for startup in step S210 and enter the startup state.

As described above, according to the in-vehicle network system 200 of this embodiment, the power/startup management ECU 10 receives the NM message that selectively instructs the startup of multiple lower ECUs 20, 30, 40 transmitted via the communication bus on behalf of the multiple lower ECUs 20, 30, 40. The power/startup management ECU 10 then turns on the relay circuits 15, 16 connected to the lower ECUs 20, 30, 40 instructed to start by the NM message. As a result, the lower ECUs 20, 30, 40 instructed to start enter the startup state. Therefore, according to the in-vehicle network system 200 of this embodiment, it is possible to finely manage the supply and cessation of power to the lower ECUs 20, 30, 40 while configuring the system to switch the power supply to the lower ECUs 20, 30, 40 from the stopped state to the supplied state in response to the NM message instructing startup.

Furthermore, in the in-vehicle network system 200 according to this embodiment, when the NM message instructs the startup of at least one of the lower ECUs (e.g., the first and second lower ECUs 20, 30) connected to one relay circuit (e.g., the first relay circuit 15), the power/startup management ECU 10 turns on the relay circuit to which at least two lower ECUs are connected. Therefore, according to the in-vehicle network system 200 of this embodiment, even when multiple lower ECUs are connected to one relay circuit and are not necessarily instructed to supply or cease power at the same timing, it is possible to appropriately implement power supply to multiple lower ECUs via one relay circuit.

### Second Embodiment

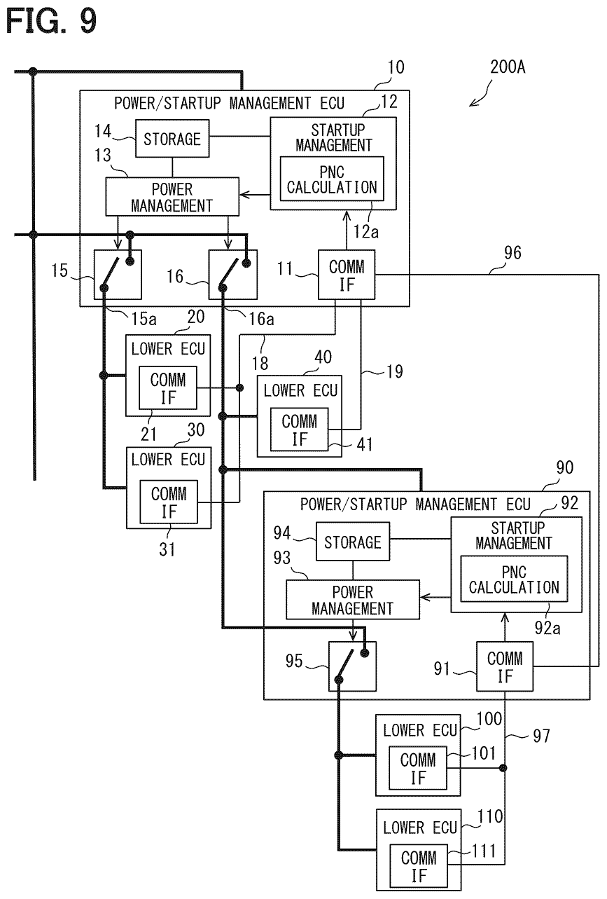

The second embodiment of the in-vehicle network system and control method for the in-vehicle network system according to the present disclosure will be described. FIG. 9 is a configuration diagram showing an example of the configuration of the in-vehicle network system 200A according to this embodiment. FIG. 9 shows only part of the configuration of the in-vehicle network system 200A according to the second embodiment. The same reference numbers are assigned to configurations similar to those of the in-vehicle network system 200 according to the first embodiment.

The in-vehicle network system 200A according to this embodiment differs from the in-vehicle network system 200 according to the first embodiment in that another upper control device, the power/startup management ECU 90, and another lower control device, the seventh and eighth lower ECUs 100, 110, are connected to at least one relay circuit, specifically the second relay circuit 16, which is controlled on and off by the power/startup management ECU 10. Therefore, the power/startup management ECU 10 can switch the power supply to the power/startup management ECU 90 by controlling the on/off state of the relay circuit 16.

The power/startup management ECU 90 includes a communication IF 91, a startup management unit 92, a PNC calculation unit 92a, a power management unit 93, a storage unit 94, and a third relay circuit 95. The communication IF 91, startup management unit 92, PNC calculation unit 92a, power management unit 93, storage unit 94, and third relay circuit 95 of the power/startup management ECU 90 are configured similarly to the communication IF 11, startup management unit 12, PNC calculation unit 12a, power management unit 13, storage unit 14, and first and second relay circuits 15, 16 of the power/startup management ECU 10, and can function similarly.

In this embodiment, when the power/startup management ECUs 10, 90 are connected in multiple stages and the power/startup management ECU 10 is configured to switch the power supply to the power/startup management ECU 90, the power/startup management ECU 10 must control the on/off state of the relay circuit 16, taking into account the PNC configuration information of the seventh and eighth lower ECUs 100, 110, which are switched on and off by the power/startup management ECU 90.

Therefore, in this embodiment, the PNC calculation unit 92a of the power/startup management ECU 90 first reads the PNC configuration information of the seventh and eighth lower ECUs 100, 110 from the storage unit 94. The PNC calculation unit 92a then calculates the logical OR of the clusters of the PNC configuration information of the seventh and eighth lower ECUs 100, 110 that were read. The PNC calculation unit 92a stores the calculated logical OR as common PNC configuration information for the seventh and eighth lower ECUs 100, 110 in the storage unit 94.

When the common PNC configuration information is calculated by the PNC calculation unit 92a, the power/startup management ECU 90 notifies the power/startup management ECU 10 of the PNC configuration information based on the calculated common cluster configuration information.

Upon receiving the PNC configuration information from the power/startup management ECU 90, the power/startup management ECU 10 stores it in the storage unit 14 as the PNC configuration information of the power/startup management ECU 90. As shown in FIG. 9, when the third lower ECU 40 is connected to the second relay circuit 16 to which the power/startup management ECU 90 is connected, the PNC calculation unit 12a of the power/startup management ECU 10 calculates common PNC configuration information shared by the power/startup management ECU 90 and the third lower ECU 40 based on the PNC configuration information of the power/startup management ECU 90 and the PNC configuration information of the third lower ECU 40. The calculated PNC configuration information is stored in the storage unit 14 linked to the second relay circuit 16.

If the PNC configuration information is set for the power/startup management ECU 90, the PNC calculation unit 12a of the power/startup management ECU 10 updates the PNC configuration information of the power/startup management ECU 90 based on the logical OR of the clusters of the common PNC configuration information for the seventh and eighth lower ECUs 100, 110 and the clusters of the PNC configuration information of the power/startup management ECU 90. This is because the PNC configuration information may be set for the power/startup management ECU 90 when the power/startup management ECU 90 performs control over control targets. The update process for the PNC configuration information of the power/startup management ECU 90 can also be performed by the PNC calculation unit 92a of the power/startup management ECU 90 instead of the PNC calculation unit 12a of the power/startup management ECU 10. In this case, the updated PNC configuration information of the power/startup management ECU 90 becomes the PNC configuration information notified to the power/startup management ECU 10. Conversely, if no PNC configuration information is set for the power/startup management ECU 90, the power/startup management ECU 10 can set the common PNC configuration information for the seventh and eighth lower ECUs 100, 110 as the PNC configuration information of the power/startup management ECU 90.

FIG. 9 shows a configuration where the power/startup management ECU 90 controls the on/off state of one third relay circuit 95, but the power/startup management ECU 90 can be configured to control the on/off state of two or more relay circuits. In this case, the PNC calculation unit 92a can calculate common PNC configuration information to be notified to the power/startup management ECU 10 based on the logical OR of the clusters of the PNC configuration information of all lower ECUs connected to multiple relay circuits.

The calculation of the PNC configuration information to be notified to the power/startup management ECU 10 by the power/startup management ECU 90 and the calculation of the common PNC configuration information by the power/startup management ECU 10 can be executed when the in-vehicle network system 200 is constructed during the vehicle manufacturing stage, when the vehicle's main switch is turned on and the in-vehicle network system 200 is activated, and when the PNC configuration information of any ECU is changed by the PNC configuration information modification unit 52.

According to the in-vehicle network system 200A of the second embodiment described above, in addition to achieving the same effects as the in-vehicle network system 200 of the first embodiment, it becomes possible to connect the power/startup management ECUs 10, 90 in multiple stages. Therefore, it allows for diverse configurations of the in-vehicle network system 200A.

### (Modifications)

While the preferred embodiments of the present disclosure have been described above, the present disclosure is not limited to the embodiments described above and can be implemented in various modifications without departing from the spirit of the present disclosure.

For example, in the embodiments described above, the first to third lower ECUs 20, 30, 40 connected to the first and second relay circuits 15, 16, which are turned on and off by the power/startup management ECU 10, were all described as NM non-compatible ECUs. However, the lower ECUs connected to the relay circuits may all be NM compatible ECUs. Alternatively, multiple lower ECUs connected to one relay circuit may all be NM compatible ECUs.

The systems and methods described in the present disclosure may be implemented by a dedicated computer configured with a processor programmed to execute one or more functions embodied by a computer program. The systems and methods described in the present disclosure may also be implemented using dedicated hardware logic circuits. Furthermore, the systems and methods described in the present disclosure may be implemented by one or more dedicated computers configured with a combination of a processor executing a computer program and one or more hardware logic circuits. For example, some or all of the functions provided by the power/startup management ECU 10 may be realized as hardware. The manner of implementing certain functions as hardware may include using one or more ICs, among other methods. Some or all of the functions provided by the power/startup management ECU 10 may be realized using a System-on-Chip (SoC), Integrated Circuit (IC), or Field-Programmable Gate Array (FPGA). The concept of IC includes Application Specific Integrated Circuit (ASIC). Additionally, the computer program may be stored as instructions executable by a computer on a non-transitory tangible storage medium. As a recording medium for the program, HDD (Hard-disk Drive), SSD (Solid State Drive), flash memory, etc., can be adopted. Moreover, the form of a program to make a computer function as the power/startup management ECU 10, and non-transitory tangible storage media such as semiconductor memory recording this program, are also included within the scope of the present disclosure.

What is claimed is:

1. An in-vehicle network system comprising:
a plurality of control devices connected to a communication bus and configured to communicate with each other in a vehicle,
wherein:
the plurality of the control devices includes at least one upper control device and a plurality of lower control devices;
the at least one upper control device includes at least one of (i) a circuit and (ii) a processor with a memory storing computer program code executable by the processor, the at least one of the circuit and the processor configured to cause the upper control device to implement
a power management unit configured to turn on and off at least one relay circuit provided in a power supply line of each of the plurality of the lower control devices, and
a startup management unit configured to receive a network management message on behalf of a plurality of lower control devices, wherein the network management message is transmitted via the communication bus and selectively instructs a startup of the plurality of the lower control devices, to instruct the power management unit to turn on the relay circuit provided in the power supply line of the lower control device for which startup is instructed by the network management message, and to supply power to the lower control device for which the startup is instructed;
the at least one relay circuit among a plurality of relay circuits is connected to at least two of the lower control devices; and
the startup management unit instructs the power management unit to turn on the relay circuit to which the at least two of the lower control devices are connected when startup of at least one of the lower control devices among the at least two of the lower control devices is instructed by the network management message.

2. The in-vehicle network system according to claim 1, wherein
the network management message includes startup cluster information that specifies a startup cluster indicating a group of the control devices to be started;
the at least one upper control device further includes a storage unit configured to store cluster configuration information indicating a cluster to which the lower control devices belong for each of the plurality of lower control devices; and
the startup management unit determines that the startup of the lower control devices corresponding to the cluster configuration information is instructed by the network management message when the startup cluster specified by the startup cluster information in the network management message matches the cluster in the cluster configuration information stored in the storage unit.

3. The in-vehicle network system according to claim 2, wherein
the at least one of the circuit and the processor configured to cause the upper control device to further implement
a modification unit configured to change the cluster configuration information of each of the plurality of the lower control devices, stored by the at least one upper control device.

4. The in-vehicle network system according to claim 3, wherein
the modification unit is implemented in any of the plurality of the control devices connected to the communication bus.

5. The in-vehicle network system according to claim 2, wherein
the at least one upper control device includes a storage unit configured to store both the cluster configuration information of each of the plurality of the lower control devices and relay connection information indicating a correspondence between the plurality of the lower control devices and the plurality of the relay circuits.

6. The in-vehicle network system according to claim 5, wherein
the at least one upper control device, based on the cluster configuration information and the relay connection information, turns on the relay circuit corresponding to the lower control device for which the startup cluster specified by the startup cluster information included in the network management message matches the cluster in the cluster configuration information, and turns off the relay circuit corresponding to the lower control device for which the startup cluster specified by the startup cluster information included in the network management message does not match the cluster of the cluster configuration information.

7. The in-vehicle network system according to claim 2, wherein
the at least two of the lower control devices connected to one relay circuit are network management non-compatible control devices that do not have a function to determine a match or mismatch between the startup cluster of the startup cluster information and the cluster of the cluster configuration information upon receiving the network management message and to set the lower control device to a startup state upon determining the match.

8. The in-vehicle network system according to claim 2, wherein
at least two of the lower control devices connected to one relay circuit are network management compatible control devices that have a function to determine a match or mismatch between the startup cluster of the startup cluster information and the cluster of the cluster configuration information upon receiving the network management message and to set the lower control device to a startup state upon determining the match.

9. The in-vehicle network system according to claim 2, wherein
the at least one of the circuit and the processor configured to cause the upper control device to further implement
a common cluster configuration information calculation unit configured to calculate common cluster configuration information shared by the at least two of the lower control devices based on a logical OR of clusters of the cluster configuration information of each of the at least two of the lower control devices connected to one relay circuit.

10. The in-vehicle network system according to claim 9, wherein
the at least one relay circuit among the plurality of the relay circuits is connected to a different upper control device, and
the at least one upper control device is configured to switch a presence or absence of power supply to the different upper control device.

11. The in-vehicle network system according to claim 10, wherein
the different upper control device includes at least one of (i) a different circuit and (ii) a different processor with a different memory storing computer program code executable by the different processor, the at least one of the different circuit and the different processor configured to cause the different upper control device to implement
a power management unit configured to turn on and off at least one different relay circuit provided in the power supply line where the power supply is switched by the at least one upper control device,
the different relay circuit is connected to at least two different lower control devices,
the at least one of the different circuit and the different processor configured to cause the different upper control device to implement
a common cluster configuration information calculation unit configured to calculate common cluster configuration information shared by the at least two different lower control devices based on logical OR of the clusters of the cluster configuration information of each of the at least two different lower control devices, and
the different upper control device notifies the at least one upper control device of the cluster configuration information based on the calculated common cluster configuration information.

12. The in-vehicle network system according to claim 11, wherein
the common cluster configuration information calculation unit of the at least one upper control device or the different upper control device updates the cluster configuration information of the different upper control device based on logical OR of the cluster of the common cluster configuration information and the cluster of the cluster configuration information of the different upper control device when the cluster configuration information is set for the different upper control device.

13. The in-vehicle network system according to claim 11, wherein
the at least one upper control device stores the cluster configuration information in a storage unit as the cluster configuration information of the different upper control device when the cluster configuration information is notified from the different upper control device.

14. A method for controlling an in-vehicle network system including a plurality of control devices connected to a communication bus and configured to communicate with each other in a vehicle, wherein the plurality of the control devices includes at least one upper control device and a plurality of lower control devices, and the at least one upper control device is configured to turn on and off at least one relay circuit provided in each power supply line of the plurality of the lower control devices, the method comprising:
receive a network management message on behalf of a plurality of lower control devices, wherein the network management message is transmitted via the communication bus and selectively instructs a startup of the plurality of the lower control devices, and
supplying power to the lower control device for which the startup is instructed by turning on the relay circuit provided in the power supply line of the lower control device for which the startup is instructed by the network management message,
wherein
the at least one relay circuit among a plurality of relay circuits is connected to at least two of the lower control devices, and
supplying power to the lower control devices includes turning on the relay circuit to which at least two of the lower control devices are connected when startup of at least one of the lower control devices among the at least two of the lower control devices is instructed by the network management message and supplying power to the at least two of the lower control devices.
